(19) United States
(12) Patent Application Publication
(10) Pub. No.: US 2014/0260852 A1
(43) Pub. Date: Sep. 18, 2014

(54) Piston for a Pneumatic Cylinder Including a Stress Concentration Structure

(71) Applicants: Robert Bosch GmbH, Stuttgart (DE); Robert Bosch Tool Corporation, Broadview, IL (US)

(72) Inventor: Eric Laliberte, Naperville, IL (US)

(73) Assignees: Robert Bosch GmbH, Stuttgart (DE); Robert Bosch Tool Corporation, Broadview, IL (US)

(21) Appl. No.: 14/210,556

(22) Filed: Mar. 14, 2014

Related U.S. Application Data
(60) Provisional application No. 61/793,550, filed on Mar. 15, 2013.

(51) Int. Cl. B26D 7/22; B23D 45/06; B23D 59/00; F16P 3/12

(52) U.S. Cl. CPC B26D 7/22; F16P 3/12; B23D 45/065; B23D 59/002
USPC 83/58; 92/15

(57) ABSTRACT

A pneumatic cylinder associated with a table saw includes a housing, a charge, and a piston assembly. The housing defines a cavity and is supported by a frame of a table saw. The charge is located within the cavity. The piston assembly is located within the cavity and includes an attachment structure engaged to the housing and a piston head releaseably connected to the attachment structure and in response to activation of the charge the piston head is configured to (i) disconnect from the attachment structure, and (ii) move away from the attachment structure. A swing arm of the table saw is configured to move from a raised position to a lowered position in response to movement of the piston head.

This application claims the benefit of priority of U.S. provisional application Ser. No. 61/793,550, filed Mar. 15, 2013, the disclosure of which is herein incorporated by reference in its entirety.

### FIELD

This disclosure relates generally to power saws and particularly to power saws including a safety mechanism having a pyrotechnic-activated pneumatic cylinder.

### BACKGROUND

A number of power tools have been produced to facilitate forming a work piece into a desired shape. One such power tool is a table saw. A wide range of table saws are available for a variety of uses. Some table saws such as cabinet table saws are very heavy and relatively immobile. Other table saws, sometimes referred to as jobsite table saws, are relatively light and portable.

Some accuracy is typically sacrificed in making a table saw sufficiently light to be mobile. The convenience of locating a table saw at a jobsite, however, makes jobsite table saws very desirable in applications such as general construction projects.

All table saws, including cabinet table saws and jobsite table saws, present a safety concern because the saw blade of the table saw is typically very sharp and moving at a high rate of speed. Accordingly, severe injury such as severed digits and deep lacerations can occur almost instantaneously. A number of different safety systems have been developed for table saws in response to the dangers inherent in an exposed blade moving at high speed. One such safety system is a blade guard. Blade guards movably enclose the saw blade, thereby providing a physical barrier that must be moved before the rotating blade is exposed. While blade guards are effective to prevent some injuries, the blade guards can be removed by a user either for convenience of using the table saw or because the blade guard is not compatible for use with a particular shaping device. By way of example, a blade guard is typically not compatible with a dado blade and must typically be removed when performing non-through cuts.

Table saw safety systems have also been developed which are intended to stop the blade when a user's hand approaches or touches the blade. Various stopping devices have been developed including braking devices which are physically inserted into the teeth of the blade. Such approaches are extremely effective. Upon actuation of this type of braking device, however, the blade is typically ruined because of the braking member. Additionally, the braking member is typically destroyed. Accordingly, each time the safety device is actuated; significant resources must be expended to replace the blade and the braking member. Another shortcoming of this type of safety device is that the shaping device must be toothed. Moreover, if a spare blade and braking member are not on hand, a user must travel to a store to obtain replacements. Thus, while effective, this type of safety system can be expensive and inconvenient.

Some safety systems incorporating blade braking systems also move the blade below the surface of the table saw. In this type of system, a pneumatic cylinder is typically activated to push the blade below a workpiece support surface of the table in event of user contact with the blade. It is desirable for the blade to be pushed below the workpiece support as quickly as possible.

Therefore, further developments that improve the speed with which a pneumatic cylinder is able to push a blade or other shaping device below a workpiece support surface are desirable.

### SUMMARY

According to an exemplary embodiment of the disclosure, a pneumatic cylinder associated with a table saw includes a housing, a charge, and a piston assembly. The housing defines a cavity and is supported by a frame of a table saw. The charge is located within the cavity. The piston assembly is located within the cavity and includes an attachment structure engaged to the housing and a piston head releaseably connected to the attachment structure and in response to activation of the charge the piston head is configured to (i) disconnect from the attachment structure, and (ii) move away from the attachment structure. A swing arm of the table saw is configured to move from a raised position to a lowered position in response to movement of the piston head.

According to another exemplary embodiment of the disclosure, a table saw includes a pneumatic cylinder, a swing arm assembly, and a sensing and control circuit. The pneumatic cylinder includes (i) a housing defining a cavity and supported by a frame of a table saw, (ii) a charge located within the cavity, and (iii) a piston assembly located within the cavity and including an attachment structure engaged to the housing and a piston head releaseably connected to the attachment structure and in response to activation of the charge the piston head is configured to disconnect from the attachment structure and to move away from the attachment structure. The swing arm assembly is pivotably supported by the frame and configured to rotate a saw blade, the swing arm assembly is configured to be moved from a raised position to a lowered position by the piston head in response to movement of the piston head. The sensing and control circuit is operably connected to the pneumatic cylinder and is configured to activate the charge in response to detecting a sensed condition.

### BRIEF DESCRIPTION OF THE FIGURES

The following detailed description references the accompanying figures in which:

FIG. 1 is a perspective view of a table saw including a pneumatic cylinder as described herein;

FIG. 2 is a perspective view of a portion of the table saw of FIG. 1 showing a swing arm assembly of the table saw in a raised position;

FIG. 3 is a perspective view of another portion of the table of FIG. 1, showing the swing arm assembly in the lowered position after activation of the pneumatic cylinder;

FIG. 4 is a cross sectional view of the pneumatic cylinder of FIG. 1 connected to a load, such as the swing arm assembly, for example;

FIG. 5 is a perspective view of a piston assembly of the pneumatic cylinder of FIG. 1, the piston assembly including stress concentration structures;

FIG. 6 is an elevational view of the piston assembly of FIG. 5;

FIG. 7 is a cross sectional view of the piston assembly of FIG. 5;

FIG. 8 is an elevational view of one of the stress concentration structures of the piston assembly of FIG. 5;

FIG. 9A is a cross sectional view of another embodiment of a pneumatic cylinder, the pneumatic cylinder is connected to a load, such as the swing arm assembly, for example;

FIG. 9B is a perspective view of a piston assembly of the pneumatic cylinder of FIG. 9A, the piston assembly including stress concentration structures;

FIG. 9C is an elevational view of the piston assembly of FIG. 9B;

FIG. 9D is a cross sectional view of the piston assembly of FIG. 9B;

FIG. 10A is a perspective view of another embodiment of a pneumatic cylinder, the pneumatic cylinder is not connected to a load and does not include stress concentration structures; and

FIG. 10B is an elevational view of the piston assembly of FIG. 10A;

FIG. 10C is a cross sectional view of the piston assembly of FIG. 10A;

FIG. 11A shows the piston assembly of FIG. 10A included in a pneumatic cylinder, the pneumatic cylinder is connected to a load;

FIG. 11B is a perspective view of the piston assembly of FIG. 10A connected to a load and under stress;

FIG. 11C is an elevational view of the piston assembly of FIG. 11B; and

FIG. 11D is a cross sectional view of the piston assembly of FIG. 11B also under stress.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

As shown in FIG. 1, a table saw 100 includes a base housing 102 and a work-piece support surface 104. A riving knife or splitter 106 is positioned adjacent to a blade 108 which extends from within the base housing 102 to above the work-piece support surface 104. A blade guard (not shown) is attached to the splitter 106 in some configurations. An angle indicator 110 indicates the angle of the blade 108 with respect to the work-piece support surface 104. A bevel adjust turn-wheel 112 is used to establish the angle of the blade 108 with respect to the work-piece support surface 104 by pivoting a frame 114 (shown in FIG. 2) within the base housing 102.

The frame 114 supports a motor 116 which is powered through a switch 118 located on the base housing 102. The frame 114 further supports a carriage assembly 120 and a stop pad 122. The carriage assembly 120 includes a carriage 124 and two guiderails 126, 128. The position of the carriage 124 along the guiderails 126, 128 is controlled by a blade height turn-wheel 130 through a gearing assembly 132. The carriage 124 fixedly supports a latch assembly 140 and pivotably supports a swing arm assembly 142.

The swing arm assembly 142 is pivotably supported by the frame 114. In particular, the swing arm assembly 142 is pivotably connected to the carriage 124 and is configured for movement between a raised position (FIGS. 1 and 2) and a lowered position (FIG. 3) in which the swing arm assembly 142 contacts the stop pad 122. In the raised position, the swing arm assembly 142 is supported by the latch assembly 140 and the blade 108 is positioned to cut a workpiece. In the lowered position the blade 108 is positioned completely below the workpiece support surface 104. The swing arm assembly 142 is further configured to support and to rotate the saw blade 108.

As shown in FIG. 3, the table saw 100 further includes a pneumatic cylinder 200 and a sensing and control circuit 204. In the exemplary embodiment, of FIG. 3, the pneumatic cylinder 200 is connected to the latch assembly 140. The sensing and control circuit 204, which is also connected to the latch assembly 140, is operably connected to the pneumatic cylinder 200 and is configured to activate the charge 220 of the pneumatic cylinder 200 in response to a sensed condition. Any desired sensing and control circuit is usable for this purpose. An exemplary sensed condition includes a non-workpiece contacting the blade 108. The term “non-workpiece” includes any object or thing that the user seeks to avoid coming into contact with the blade 108.

With reference to FIG. 4, the pneumatic cylinder 200 or “pyrotechnic cylinder” includes a housing 208, a piston assembly 212, a pin 216, and a pyrotechnic charge 220. The housing 208 defines a generally cylindrical interior cavity 224 that defines an inside diameter 228. The housing 208 is formed from a rigid material that is configured to withstand the typical effects of an activated pyrotechnic charge. The housing 208 is supported by the frame 114 (FIG. 2) of the table saw 100. Exemplary materials for forming the housing 208 include steel and aluminum.

The piston assembly 212 (as shown in FIGS. 5-7) is located within the cavity 224. The piston assembly 212 includes a piston head 232 releaseably connected to an attachment structure 236 by at least one rib 240.

The piston head 232 defines a generally circular periphery having an outside diameter 244 (FIG. 6) that is slightly less than the inside diameter 228. Accordingly, the piston head 232 is configurable to slide within the cavity 224. In some embodiments, the piston head 232 includes a seal or a ring (not shown) that is configured to form a substantially air tight seal between the piston head and the portion of the housing 208 defining the cavity 224.

The attachment structure 236 is also positioned in the interior cavity 224. The attachment structure 236 is engaged to the housing 208 in a generally fixed position within the cavity 224.

The exemplary piston assembly 212 of FIGS. 5, 6, and 7 includes two of the ribs 240 that connect the piston head 232 to the attachment structure 236. Each of the ribs 240 includes a stress concentration structure 248 that releaseably connects the piston head 232 to the attachment structure 236 and defines a notch 252. The stress concentration structures 248 are spaced apart from the piston head 232 and the attachment structure 236. The stress concentration structures 248 are positioned closer to the piston head 232 than to the attachment structure 236. The piston head 232 is configured to separate from the attachment structure 236 upon fracture of the stress concentration structures 248 in response to activation of the charge 220.

As shown in FIG. 8, the notches 252 are generally triangular voids that define a minimum width of the ribs 240. In the exemplary illustrated embodiment, the minimum width of the notches 252 extends through approximately two thirds of a maximum width 256 of the ribs 240. The stress concentration structure 248 is configured to fracture at the notch 252 into a first rib portion (left side, in FIG. 8) and a second rib portion (right side, in FIG. 8). In another embodiment the minimum width of the notches 252 extends through approximately 5% to 90% of the thickness 256. The stress concentration structures 248 are not limited to notches, and include any deliberate change in geometry that speeds the failure/fracture of the supporting ribs 240 in response to activation of the pneumatic cylinder 100. In another embodiment, as shown in FIGS. 9A, 9B, 9C, and 9D, the notches 352 of the stress concentration structures 348 are located at the intersection of the piston head 232 and the ribs 240.

As shown in FIG. 4, the pin 216 extends between the piston head 232 and a mass, which represents the swing arm assembly 142, in this embodiment. The pin 216 is a ridged member configured to transfer force from the piston head 232 to the swing arm assembly 142 to move the swing arm assembly 142 toward the lowered position.

The pyrotechnic charge 220 is positioned between the piston head 232 and the attachment structure 236 within cavity 224. In one embodiment, the pyrotechnic charge 220 surrounds the ribs 240. The pyrotechnic charge 220 is configured to undergo an exothermic chemical reaction that results in an extremely rapid production of a gas. That is, the pyrotechnic charge 220 is configured to “explode” upon receiving a firing current. The pyrotechnic charge 220 is formed from any desired pyrotechnic material/compound, as desired by those of ordinary skill in the art.

In operation, the sensing and control circuit 204 activates the pneumatic cylinder 200 in response to a sensed condition. When the pneumatic cylinder 200 is activated, the pyrotechnic charge 220 explodes and generates a region of extremely high pressure between the piston head 232 and the attachment structure 236.

The high pressure between the piston head 232 and the attachment structure 236 causes the piston head to separate/disconnect from the attachment structure at the weakest point therebetween. The weakest point is configured to be the stress concentration structures 248. Accordingly, the high pressure causes the ribs 240 to separate/fail/fracture into two sections at the notches 252.

Separation of the piston head 232 from the ribs 240 and the attachment structure 236 enables the gas generated by the pyrotechnic charge 220 to rapidly propel the piston head 232 away from the attachment structure 236. Movement of the piston head 232 results in movement of the pin 216 to impact a strike plate 143 (see FIG. 3) on the swing arm assembly 142, which causes the swing arm assembly 142 to move to the lowered position (FIG. 3) and prevents any portion of the blade 108 from extending above the workpiece support surface 104.

Movement of the blade 108 to a position below the workpiece support surface 104 protects the user in at least two ways. First, as the height of the saw blade 108 above the workpiece support surface 104 is decreased, the contact point between the non-workpiece and the blade 108 accelerates away from the user. Typically speeds of 2 m/s are achievable in less than 0.4 ms. Second, the user and the non-workpiece are shielded from the blade 108 because the workpiece support surface 104 acts as a barrier.

Data associated with the firing of the pyrotechnic charge 220 show two distinct delays from the firing current being applied to the pyrotechnic charge 220 until the piston head 232 starts to move. With reference to FIGS. 10A, 10B, and 10C, without a load, the data shows that a piston head 332 without the stress concentration structures 248 starts to move away from the attachment structure 336 in under 0.400 mS. As shown in FIG. 11A, 11B, 11C, and 11D, when the load is applied (as represented by swing arm assembly 142), movement of the piston head 332 is delayed by approximately 1.5 ms until after the firing current is applied. This delay is recognizable by comparing the hypothetical and actual reaction times.

The data further show that known pneumatic cylinders have a delay of 0.35 ms from the generation of the firing current to movement of the piston head 332 when no external load 142 is applied. This is viewed as a baseline or best case for this class of device. The application of an external load 142 increases this time to 1.0 ms to 1.5 ms. Pressures internal to the known cylinder take the same amount of time to develop in either case. The forces applied to the internal retaining ribs are sufficient to surpass the materials failure stress within the 0.35 ms time frame.

The root cause for the performance difference (i.e. between a load condition and a no load condition) is that the external load affects the rate at which strain is applied to the ribs 340. Computer simulation (FEA) calculations have confirmed this hypothesis. Controlling the way the ribs 340 react to strain leads to the desired rib failure in nearly the same duration as the baseline case. This is what the ribs 240 having the stress concentration structures 248 are configured to accomplish.

There are many benefits to decreasing the reaction time of movement of the piston head 232. For example, if the user of the table saw 100 approaches the blade 108 with a non-workpiece at 2 m/s, the extra 1.0 ms of time savings generated by the cylinder 200 yields a reduction in depth of cut of 2 mm. At the highest expected injury speed of 6 m/s, such as those potentially created by kickback, the reduction reaches 6 mm. This is a significant advantage to the user.

Therefore, it is desirable for the stress concentration structures 248 to fail with a minimum amount of deflection in order to limit the time it takes to break the piston head 232 away from the attachment structure 236 even when an external load (e.g. the swing arm assembly 142) is applied to the piston head 232. Exemplary methods of causing the stress concentration structures 248 to fail with a minimum amount of deflection include 1) stress concentration geometry, 2) stiff materials that act brittle during the high strain rates exhibited during the firing forces, 3) creation of differential pressures on opposite sides of the retaining ribs, 4) changing the retention from integral parts to retention fits such as locking tapers or snap fits, and 5) a combination of these methods.

Based on the above, four unique configurations for achieving strain control are described herein. The first method is an application of stress concentration points. As shown in FIGS. 10A, 10B, 10C and 11A, 11B, 11C, 11D, when piston retention ribs 340 have uniform geometry (i.e. no stress concentration structures), the strain caused by firing the pyrotechnic charge affects the ribs uniformly. In ribs 340 with a length of 5 mm, the ribs 340 under several tenths of a millimeter of strain before failing.

FIG. 10 shows the effects of the strain as the ribs 340 display the characteristic “necking” seen in plastic deformation leading to failure. The “necking” is undesirable since the time required for the ribs 340 to stretch “several tenths of a millimeter” is time that the piston head 332 is prevented from accelerating away from the attachment structure 336 at a high rate.

Adding a stress concentration structure 248, such as the notches 252, has a dramatic effect on the firing time. As shown by FIG. 5, the stress is very much concentrated at the apex/point of the notches 252, which reduces the amount of stretch that occurs before failure, thereby decreasing the time it takes the ribs 240 to fail.

The next configuration for achieving strain control is changing material properties. Strain control is achievable by changing the material used to manufacture the piston assembly 212. The piston assembly 212 uses PA6-30GF with an elongation at break of approximately 1%. Other suitable materials for forming the piston assembly 212 include PolyOne Therma-Tech™ SF-5000C TC Polyphenylene Sulfide (PPS), which has an elongation at break of 0.2%. Additionally, Vyncolit 3520 CG Novolac Phenolic is configurable to have 0.2-0.3% elongation at break. It is desirable for the system to move less before failure is achieved.

According to another one of the configurations, if the structure of the piston assembly 212 seals the explosive into a region of limited volume, this differential pressure will cause the retention ribs 240 to rupture/fracture. This configuration changes the direction of deflection required to create failure from a linear translation to radial expansion. The piston assembly 212 is configured to direct the pressure into breaking the ribs 240 and not to escaping the seals.

Based on another configuration to achieve stain control, rather than connecting the piston head 232 to the attachment structure 236 via an overmolded connection, the piston head 232 and the attachment structure 236 are physically joined using a press fit, lock taper, or other mechanical fit. The explosive pressure is then configured to overcoming the joint forces and friction. In this configuration there is nothing to break. Note that overtime these joint forces will decrease as the plastic creeps away from the fit. This could make this type of joint the fastest to disengage.

The efficacy of the solutions and methods presented above was determined through finite element analysis. The analysis assumes sharp corners, perfect material homogeneity, and that the material's strain rate curve matches the application. Deviations from these assumptions typically cause results that are different from the analysis presented above and shown in the figures; nonetheless, the trends still stand.

Any of the above-described methods and configurations are combinable to optimize the firing time. For example, using a stress concentrating notch in a brittle material that contains the explosive forces could maximize control over the time to failure.

A number of other embodiments of the cylinder 200 are described below.

First, it is desirable for a pneumatic cylinder 200 to include a piston 232 initially connected to a ground structure 236 which contains or surrounds a pyrotechnic charge 220 designed to explode and create a differential pressure. The connection 240 to the piston 232 is configured to separate (to break). The connection 240 has geometric features configured to accelerate the failure.

Second, a pneumatic cylinder 200 includes a piston 232 initially connected to a ground structure 236 which contains or surrounds a pyrotechnic charge 220 configured to explode and create a differential pressure. The connection 240 to the piston 232 is configured to separate (to break). The connection 240 has more brittle material properties than PA6-GF-30 configured to accelerate the failure.

Third, a pneumatic cylinder 200 includes a piston 232 initially connected to a ground structure 236 which contains or surrounds a pyrotechnic charge 220 configured to explode and create a differential pressure. The connection 240 to the piston 232 is configured to separate (to break) and separates the initial explosive volume from a second volume at atmospheric pressure. The differential pressure created during the explosion creates a failure in the connecting ribs 240.

Fourth, a pneumatic cylinder 200 includes a piston 232 initially connected to a ground structure 236 which contains or surrounds a pyrotechnic charge 220 configured to explode and create a differential pressure. The connection 240 to the piston 232 is configured slide apart when exposed to the explosive pressure.

Also, another embodiment uses a combination of the techniques and components described above in embodiments one through four.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A pneumatic cylinder associated with a table saw comprising:
a housing defining a cavity and supported by a frame of a table saw;
a charge located within the cavity; and
a piston assembly located within the cavity and including an attachment structure engaged to the housing and a piston head releaseably connected to the attachment structure and in response to activation of the charge the piston head is configured to (i) disconnect from the attachment structure, and (ii) move away from the attachment structure,
wherein a swing arm of the table saw is configured to move from a raised position to a lowered position in response to movement of the piston head.

2. The pneumatic cylinder of claim 1, wherein the piston head is releaseably connected to the attachment structure by at least one stress concentration structure at which the piston head is configured to separate from the attachment structure upon fracture of the at least one stress concentration structure in response to activation of the charge.

3. The pneumatic cylinder of claim 2, wherein:
the at least one stress concentration structure defines a notch and a minimum width at the notch, and
the at least one stress concentration structure is configured to fracture at the notch.

4. The pneumatic cylinder of claim 3, wherein:
the at least one stress concentration structure defines a maximum width; and
the minimum width is less than or equal to one third of the maximum width.

5. The pneumatic cylinder of claim 2, wherein the at least one stress concentration structure defines a generally triangular void.

6. The pneumatic cylinder of claim 2, wherein:
the piston assembly further includes at least one rib extending from the piston head to the attachment structure, and
the at least one rib includes the at least one stress concentration structure.

7. The pneumatic cylinder of claim 6, wherein the at least one stress concentration structure is located closer to the piston head than to the attachment structure.

8. The pneumatic cylinder of claim 6, wherein the at least one stress concentration structure is located at an intersection of the piston head and the at least one rib.

9. The pneumatic cylinder of claim 6, wherein in response to actuation of the charge the at least one rib is configured to fracture into a first rib portion and a second rib portion at the at least one stress concentration structure.

10. The pneumatic cylinder of claim 6, wherein the at least one rib is a first rib and the at least one stress concentration structure is a first stress concentration structure, and the piston assembly further includes:
a second rib extending from the piston head to the attachment structure and including a second stress concentration structure at which the piston head is configured to separate from the attachment structure upon fracture of the at least one stress concentration structure in response to activation of the charge.

11. A table saw comprising:
a pneumatic cylinder including (i) a housing defining a cavity and supported by a frame of a table saw, (ii) a charge located within the cavity, and (iii) a piston assembly located within the cavity and including an attachment structure engaged to the housing and a piston head releaseably connected to the attachment structure and in response to activation of the charge the piston head is configured to disconnect from the attachment structure and to move away from the attachment structure;
a swing arm assembly pivotably supported by the frame and configured to rotate a saw blade, the swing arm assembly configured to be moved from a raised position to a lowered position by the piston head in response to movement of the piston head; and
a sensing and control circuit operably connected to the pneumatic cylinder and configured to activate the charge in response to detecting a sensed condition.

12. The table saw of claim 11, wherein the sensed condition includes at least a non-workpiece contacting the rotating saw blade.

13. The table saw of claim 11, wherein the piston head is releaseably connected to the attachment structure by at least one stress concentration structure at which the piston head is configured to separate from the attachment structure upon fracture of the at least one stress concentration structure in response to activation of the charge

14. The table saw of claim 13, wherein:
the at least one stress concentration structure defines a notch and a minimum width at the notch, and
the at least one stress concentration structure is configured to fracture at the notch.

15. The table saw of claim 14, wherein:
the at least one stress concentration structure defines a maximum width; and
the minimum width is less than or equal to one third of the maximum width.

16. The table saw of claim 13, wherein the at least one stress concentration structure defines a generally triangular void.

17. The table saw of claim 13, wherein the piston assembly further includes:
at least one rib extending from the piston head to the attachment structure,
wherein the at least one rib includes the at least one stress concentration structure.

18. The table saw of claim 17, wherein the at least one stress concentration structure is located closer to the piston head than to the attachment structure.

19. The table saw of claim 17, wherein:
the piston assembly further includes at least one rib extending from the piston head to the attachment structure, and
the at least one rib includes the at least one stress concentration structure.

20. The table saw of claim 17, wherein in response to actuation of the charge the at least one rib is configured to fracture into a first rib portion and a second rib portion at the at least one stress concentration structure.
